(19) United States
(12) Patent Application Publication
(10) Pub. No.: US 2007/0217767 A1
(43) Pub. Date: Sep. 20, 2007

(54) Method of managing media files and media playback apparatus

(75) Inventors: Ching-Shih Tsao, Taipei City (TW); Wen-Chun Lin, Taipei City (TW); Hsu-Hsun Tsai, Taipei City (TW); Cheng-Wei Chou, Taipei City (TW); Shih-Lon Chen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTek COMPUTER INC.

(21) Appl. No.: 11/717,756

(22) Filed: Mar. 14, 2007

(30) Foreign Application Priority Data
Mar. 16, 2006 (TW) 095109042

(51) Int. Cl. H04N 5/00

(52) U.S. Cl. 386/125

(57) ABSTRACT

The invention relates to a method of managing media files received under different transmission modes and related media playback apparatus thereof. The method includes receiving a media file; retrieving media information from the media file regardless of what transmission mode is used when the media file is received; and modifying a media information record corresponding to the media file according to the retrieved media information.

### BACKGROUND OF THE INVENTION

1. Field of the Invention

The present invention relates to a data accessing mechanism, and more particularly, to a method of managing media files received under different transmission modes for improving media file management efficiency and related media playback apparatus thereof.

2. Description of the Prior Art

As the electronic industry progresses through time, the advancement of portable electronic products has also increased significantly. In general, early digital recorders only offered functions such as sound recording and playback, whereas digital recorders today offer more advanced functions such as FM broadcast receiving, MP3 playback, and language learning programs. One of the most popular functions of digital recorders today is the MP3 playback mode. In order to play an MP3 file, users must utilize a software application to download the MP3 file from a computer to a memory block of a media playback apparatus, such as a digital recorder, where the commonly used software application loads the MP3 file by a mass storage class (MSC) mode or a media transfer protocol (MTP) developed by Microsoft. Additionally, tags carrying information such as the title of the song, the name of the artist and the album, and the style of the song are loaded into the media playback apparatus while the MP3 file is being loaded. However, while media playback apparatuses used on the market today are operating under one transmission mode, they are unable to recognize the tags and the stored information utilizing the other mode. Consequently, the media playback apparatuses are unable to simultaneously manage the files downloaded via two different transmission modes, and in order to manage the files more conveniently, users must use only a single transmission mode or software application to download the songs.

### SUMMARY OF THE INVENTION

It is therefore one of the objectives of the present invention to provide a method for managing media files received under different transmission modes and related playback apparatus thereof to solve the above-mentioned problems.

According to one aspect of the present invention, a method of managing media files is disclosed, in which the media files are received under different transmission modes. The method includes: receiving a media file; retrieving media information from the media file regardless of what transmission mode is used when the media file is received; and modifying a media information record corresponding to the media file according to the retrieved media information.

According to another aspect of the present invention, a media playback apparatus is disclosed, in which the media playback apparatus is able to manage media files received under different transmission modes. The media playback apparatus includes a transmission interface, a database, and a control unit. Preferably, the transmission interface is utilized to receive a media file, the database is coupled to the transmission interface for storing at least a media information record corresponding to the media file, and the control unit is coupled to the transmission interface and the database for retrieving a media information from the media file regardless of what transmission mode is used when the media file is received and modifying the media information record according to the retrieved media information.

The present invention utilizes a database to manage media files received under different transmission modes and manage media information of each media file into different categories. Consequently, the media playback apparatus of the embodiment of the present invention is able to access media files received under any type of transmission mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing a media playback apparatus according to an embodiment of the present invention.

FIG. 2 is a diagram showing an internal data structure of a database shown in FIG. 1.

FIG. 3 is a flow chart showing operation of the media playback apparatus shown in FIG. 1.

### DETAILED DESCRIPTION

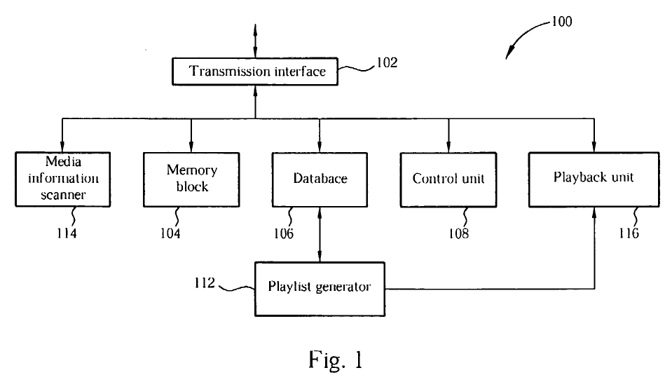

Please refer to FIG. 1. FIG. 1 is a block diagram showing a media playback apparatus 100 according to an embodiment of the present invention. As shown in FIG. 1, the media playback apparatus 100 includes a transmission interface 102, a memory block 104, a database 106, a control unit 108, a playlist generator 112, a media information scanner 114, and a playback unit 116. Preferably, users are able to select the transmission mode manually or utilize the system's auto-selection scheme to automatically select a transmission mode, such as MSC mode, MTP mode, or other modes while using the media playback apparatus 100 to download media files.

In this embodiment of the present invention, after connecting the media playback apparatus 100 to a computer, a software application, such as Windows media player is used to download the media files and playlist information stored in the computer to the media playback apparatus 100 through the transmission interface 102. The control unit 108 functions to write the media files received by the transmission interface 102 to the memory block 104. After the media files are written into the memory block 104, the control unit 108 will read the tags within the stored media files according to the transmission mode and write the tags in a corresponding field of the database 106 for generating media information records. For example, if the media files were MP3 files, the tags within the media files may contain information such as the title of the song, the name of the artists and the albums, and the style of the songs. Hence, four corresponding fields will be created in the database 106 to store the information from the tags. The database 106 may be implemented by a memory block independent from the memory block 104, in which the memory block corresponding to the database 106 and the memory block 104 can be located in two independent blocks of the same memory or in two separate memories.

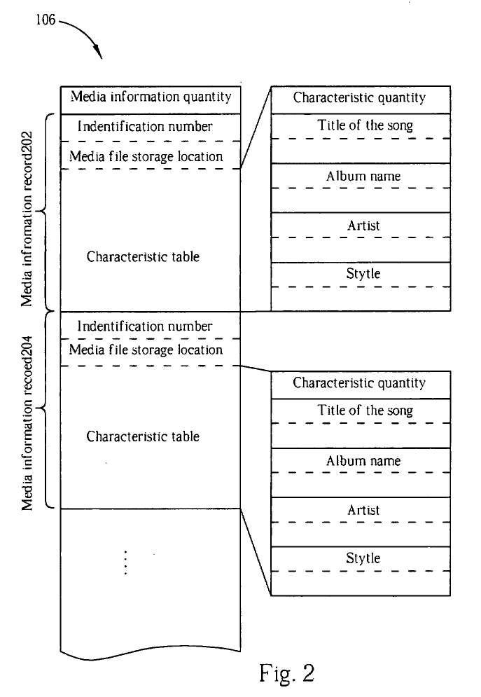

Please refer to FIG. 2. FIG. 2 is a diagram showing an internal data structure of the database 106 shown in FIG. 1. As shown in FIG. 2, the database 106 includes a field, such as the “media information quantity” field that keeps a record of the total number of media information records contained within the database 106. The database 106 also includes a plurality of media information records 202 and 204, in which each of the media information records includes an identification number serving as the primary key, a media file storage location indicating the storage location of the media files corresponding to the media information record, and a characteristics table listing the characteristics of the media files. Each characteristics table further includes a plurality of fields for storing the number of characteristics (i.e., the “characteristic quantity” shown in FIG. 2) and the content of each characteristic (i.e., the content of the tags described above).

Referring back to FIG. 1, the playlist generator 112 is then able to generate a plurality of playlists according to the aforementioned characteristics. For instance, the playlist generator 112 is able to store MP3 files of the same style in a playlist, or MP3 files corresponding to an artist to another playlist. Users are then able to select a favorite playlist and play the MP3 files sequentially according to the selected playlist. Subsequently, the playback unit 116 will read the playlist selected by the user to play the media files stored in the memory block 104. Preferably, the playlist generator 112 can be implemented by a hardware device independent from the control unit 108 or a separate program module, such as a software program. For example, if the playlist generator 112 is implemented using a program module, the control unit 108 can generate a plurality of playlists through executing the program module. Ultimately, the media playback apparatus 100 is able to provide a broader selection of playlists for users after downloading the media files and playlist information from an electronic device.

Since users are able to utilize a direct file transfer means to write the media files into the memory block 104 without going through any of the software applications, the media information scanner 114 is thus utilized periodically (or under the circumstances when a new connection to a computer is established or when the memory block 104 is updated), to scan the media files stored in the memory block 104 for verifying whether all of the media files include corresponding media information stored in the database 106. If the result demonstrates that a media file does not include corresponding media information stored in the database 106, the media information scanner 114 will drive the control unit 108 to retrieve at least a tag from the media file, and write the tag into a corresponding field of the database 106 for generating corresponding media information. Preferably, the media information scanner 114 can be implemented by a hardware device independent from the control unit 108 or a program module (i.e., a software application). For example, if the media information scanner 114 is implemented using a program module, the control unit 108 can scan the media files through executing the program module.

It should be noted that the media playback apparatus 100 not only can utilize the software applications of a personal computer to download media files, but also can utilize the MSC mode to access media files stored in other small-sized electronic devices, such as a USB personal disk. For instance, the media playback apparatus 100 will utilize the MSC mode to read and download media files stored in a USB personal disk when the USB personal disk is connected to the media playback apparatus 100. After the media files are downloaded, the media information scanner 114 will scan the media files stored in the memory block 104 and update the database 106 using the corresponding media information.

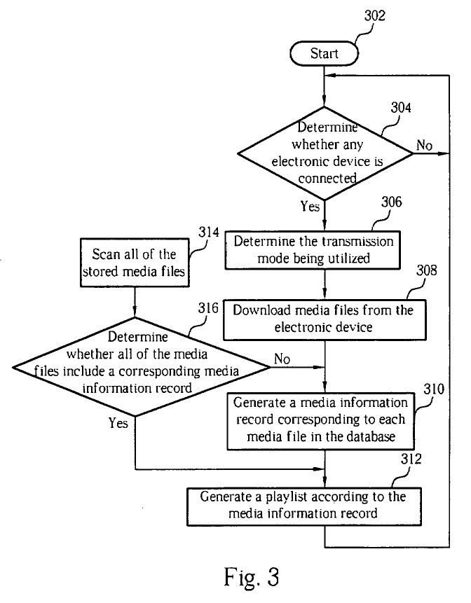

Please refer to FIG. 3. FIG. 3 is a flow chart showing operation of the media playback apparatus 100 shown in FIG. 1. According to the present embodiment, the method of managing media files received under different transmission modes includes the following steps:
Step 302: Start.
Step 304: Determine whether the media playback apparatus 100 is connected to any electronic device. If “yes” then perform step 306; otherwise, return to step 304.
Step 306: Determine the transmission mode used by the media playback apparatus 100.
Step 308: Download the media files into the media playback apparatus 100 according to the transmission mode utilized.
Step 310: Generate a media information record corresponding to each media file in the database 106.
Step 312: Generate at least a playlist according to the media information record stored in the database 106 and then return to step 304.
Step 314: Scan all of the media files within the media playback apparatus 100.
Step 316: Determine whether all of the media files include a corresponding media information record. If “yes” then perform step 312; otherwise, go to step 310.

As shown in the flow chart of FIG. 3, when the media playback apparatus 100 is connected to any electronic device, such as a personal computer or a portable storage device, the transmission mode being utilized is determined, in which the transmission mode can be selected by the users manually, assigned by the system, or selected by the media playback apparatus 100 according to whichever mode is supported by the electronic device. Next, the media playback apparatus 100 will download the media files stored in the electronic device and generate a media information record in the database 106 according to the media information of the media files. Next, at least a playlist is generated according to the media information record for the users. However, when the media information scanner 114 of the media playback apparatus 100 is enabled, the media information scanner 114 will scan all of the stored media files to ensure that each media file includes a corresponding media information record. If one of the media files has no corresponding media information record, the media information scanner 114 will drive the media playback apparatus 100 to generate a media information record for the particular media file and update the content in the database 106.

Additionally, the media playback apparatus 100 will download the media files and playlist information stored in the electronic device to provide a broader selection of playlists for the users.

In contrast to the prior art, the present invention utilizes a database to manage the tag information of media files for managing media files received under different transmission modes, and utilizes a playlist generator to generate a plurality of playlists for the users. Ultimately, the media playback apparatus of the embodiment of the present invention is able to examine or playback all of the media files received under any type of transmission mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing media files received under different transmission modes, the method comprising:
receiving a media file;
retrieving a media information from the media file regardless of the transmission mode when the media file is received; and
modifying a media information record corresponding to the media file according to the retrieved media information.

2. The method of claim 1 further comprising: playing the media file according to the media information record.

3. The method of claim 1, wherein the transmission mode comprises a mass storage class (MSC) mode.

4. The method of claim 1, wherein the transmission mode comprises a media transfer protocol (MTP) mode.

5. The method of claim 1 further comprising:
scanning a plurality of stored media files; and
when a specific media information of a specific media file of the stored media files is not recorded in a specific media information record, retrieving the specific media information of the specific media file to modify the specific media information record.

6. A media playback apparatus for managing media files received under different transmission modes, the media playback apparatus comprising:
a transmission interface for receiving a media file;
a database, coupled to the transmission interface, for storing at least a media information record corresponding to the media file; and
a control unit, coupled to the transmission interface and the database, for retrieving a media information from the media file regardless of the transmission mode when the media file is received and modifying the media information record according to the retrieved media information.

7. The media playback apparatus of claim 6 further comprising:
a playback unit, coupled to the database, for playing the media file according to the media information record.

8. The media playback apparatus of claim 6, wherein the transmission mode comprises a mass storage class (MSC) mode.

9. The media playback apparatus of claim 6 wherein the transmission mode comprises a media transfer protocol (MTP) mode.

10. The media playback apparatus of claim 6 further comprising:
a playlist generator, coupled to the database, for creating a playlist according to a specific field of the media information record corresponding to the media file.

11. The media playback apparatus of claim 6 further comprising:
a media information scanner, for scanning a plurality of media files stored in the media playback apparatus and for retrieving a specific media information of a specific media file to modify a specific media information record when the specific media information of the specific media file of the stored media files is not recorded in the specific media information record.
